(19) United States
(12) Patent Application Publication
(10) Pub. No.: US 2026/0049968 A1
(43) Pub. Date: Feb. 19, 2026

(54) CHARGE DETECTION MASS SPECTROMETRY

(71) Applicant: Waters Technologies Corporation, Milford, MA (US)

(72) Inventors: Matthew A. Lauber, North Smithfield, RI (US); Stephan M. Koza, Lancaster, MA (US); Kevin Giles, Stockport (GB); Benjamin E. Draper, Bloomington, IN (US); Lohra M. Miller, Bloomington, IN (US)

(73) Assignee: Waters Technologies Corporation, Milford, MA (US)

(21) Appl. No.: 19/294,603

(22) Filed: Aug. 8, 2025

Related U.S. Application Data
(60) Provisional application No. 63/683,732, filed on Aug. 16, 2024.

(51) Int. Cl. G01N 30/38; G01N 30/72

(52) U.S. Cl. CPC G01N 30/38; G01N 30/7233

(57) ABSTRACT

A method of mass spectrometry comprising: supplying a sample to be mass analysed to a liquid chromatography separator, whilst varying a liquid flow rate through the separator such that liquid elutes from the separator at a first rate during a first period and a second, lower rate during a second period; ionising eluant from the separator during at least the second period; and mass analysing the resulting ions, or ions derived therefrom, by charge detection mass spectrometry.

### CROSS-REFERENCE TO RELATED APPLICATION

This application claims priority from and the benefit of U.S. Application No. 63/683,732 filed on Aug. 16, 2024. The entire content of this application is incorporated herein by reference.

### FIELD OF THE INVENTION

The present invention relates generally to mass spectrometry, and in particular to charge detection mass spectrometry (CDMS) in which the charge and mass to charge ratio of an ion are detected and used to determine its mass.

### BACKGROUND

CDMS is a useful technique that enables, for example, the characterisation of large, highly-charged and heterogeneous analytes, such as whole virus capsids, that are of increasing importance in biotherapeutics. However, it can take a relatively long time to analyse a sample by CDMS, making it difficult to interface a charge detection mass spectrometer with an upstream liquid chromatography separator.

### SUMMARY

The present invention provides a method of mass spectrometry comprising: supplying a sample to be mass analysed to a liquid chromatography separator, whilst varying a liquid flow rate through the separator such that liquid elutes from the separator at a first rate during a first period and a second, lower rate during a second period; ionising eluant from the separator during at least the second period; and mass analysing the resulting ions, or ions derived therefrom, by charge detection mass spectrometry.

The separator is used to separate the sample such that different analytes in the sample arrive at an ionisation source for performing said ionising at different respective times, at least during the second period but optionally also during the first period. The separator may comprise a chromatography column in which the sample is separated. A first pump is provided for pumping the sample to the column and a second pump is provided for pumping a mobile phase to the column.

The first period may be an initial period during which the sample does not elute from the separator, and the second period is a subsequent period during which the sample does elute from the separator. Alternatively, or additionally, the first period may be a period during which no analytes of interest are expected to elute from the separator, and the second period is a period during which one or more analytes of interest are expected to elute from the separator.

The one or more analytes of interest may be one or more preselected analyte of interest.

Said supplying the sample to the separator may comprise pumping both the sample and a mobile phase to the separator during the first and second periods, wherein only the mobile phase elutes during the first period.

The sample may be supplied to the separator whilst varying the liquid flow rate through the separator such that liquid elutes from the separator at a third rate during a third period that is subsequent to the second period, wherein the third rate is higher than the second rate.

The third rate may be the same rate as the first rate, or it may be a higher or lower rate than the first rate.

Optionally, no analytes of interest are expected to elute from the separator during the third period.

Only compounds that are not analytes of interest, such as salts, may elute during the third period. However, less preferably, it is contemplated that analytes of interest may elute during the third period.

The method may comprise: switching the liquid flow rate through the separator from the first flow rate to the second flow rate when a first predetermined volume of liquid has eluted from the separator; and/or switching the liquid flow rate through the separator from the second flow rate to the third flow rate when a second predetermined volume of liquid has eluted from the separator. For example, the separation column of the separator has an internal liquid capacity and the method may switch from the first flow rate to the second flow rate at a time corresponding to when a predetermined, first percentage of the liquid capacity has eluted. Additionally, or alternatively, the method may switch from the second flow rate to the third flow rate at a time corresponding to when a second, predetermined percentage of the liquid capacity has eluted.

Alternatively, the method may comprise switching the liquid flow rate through the separator from the first flow rate to the second flow rate at a time based on when one or more analyte of interest is expected to start eluting from the separator; and/or switching the liquid flow rate through the separator from the second flow rate to the third flow rate at a time based on when the one or more analyte of interest is expected to have finished eluting from the separator.

The time at which one or more analyte of interest in the sample is expected to start eluting from the separator may be known or estimated, e.g. estimated based on theoretical calculations. For example, a portion of the sample, or a similar or duplicate sample, may have been mass analysed previously in order to determine the time at which the one or more analytes of interest start eluting from the separator. When the sample is subsequently mass analysed, the mass spectrometer may be configured to automatically switch the flow rate through the separator from the first flow rate to the second flow rate at a time that is based on the time at which the one or more analytes of interest are expected to start eluting from the separator. For instance, the mass spectrometer may switch the flow rate from the first rate to the second rate at or before the time that has been determined, or is known, that the one or more analytes of interest will start eluting from the separator. In a corresponding manner, the time at which the one or more analyte of interest in the sample is expected to finish eluting from the separator may be known or estimated. When the sample is mass analysed, the mass spectrometer may be configured to automatically switch the flow rate through the separator from the second flow rate to the third flow rate at a time that is based on the time at which the one or more analytes of interest are expected to finish eluting from the separator. For instance, the mass spectrometer may switch the flow rate from the second rate to the third rate at or after the time that has been determined, or is known, that the one or more analytes of interest will finish eluting from the separator.

Alternatively, the method may comprise spiking the sample with a first marker compound. When the mass analyser mass analyses and detects ions of the first marker compound it may automatically switch the flow rate through the separator from the first flow rate to the second flow rate. Alternatively, or additionally, the sample may be spiked with a second marker compound and when the mass analyser mass analyses and detects ions of that second marker compound it automatically switches the flow rate through the separator from the second flow rate to the third flow rate.

It will be appreciated that the first marker compound is selected to be a compound that elutes from the separator prior to or during the elution of at least some of the analytes of interest. The mass spectrometer may maintain the second flow rate until the marker compound is no longer detected, or for a predetermined time after its detection, and then switch the flow rate to the third flow rate. Alternatively, the second marker compound may be used as described above. It will be appreciated that the second marker compound is selected to be a compound that elutes from the separator after the elution of at least some of the analytes of interest.

In the method described herein, said supplying the sample to the separator may comprise: (i) pumping a mobile phase to the separator during the first and second periods, wherein the mobile phase is pumped to the separator at a lower rate during the second period than during the first and/or third period; and/or (ii) pumping the sample to the separator at a lower rate during the second period than during the first and/or third period.

Preferably, liquid elutes from the separator at a substantially constant rate during each of the first, second and third periods.

The flow rate at which liquid elutes from the separator during at least the second period may be controlled so that the duration of a chromatographic peak width of an analyte of interest from the sample substantially matches the duty cycle of the mass analyser.

Liquid may be caused to elute from the separator during the first and/or third period at a rate that is at least twice as high as during the second period.

The flow rate at which liquid elutes from the separator during the second period may be controlled so that the duration of a chromatographic peak width of an analyte from the sample is at least 40 s long. For example, the flow rate may be such that the peak width is ≥60 s, ≥80 s,≥100 s, ≥150 s, ≥200 s, ≥250 s, or ≥300 s.

Said ionising may be performed by an ionisation source and the method may comprise diverting eluant from the separator away from the ionisation source during the first and/or third period. For example, the eluant may be diverted to waste, such as a waste container, during the first and/or third period. This helps prevent contamination of the ion-optical elements in the mass spectrometer. This is particularly advantageous during the third period, so as to prevent salts from being ionised and the resulting ions transmitted into the mass spectrometer.

Said ionising may be performed by an ionisation source and the method may comprise supplying eluant from the separator to the ionisation source during the first period, but wherein the ionisation source is deactivated during the first period such that it does not ionise the eluant; and/or supplying eluant from the separator to the ionisation source during the third period, but wherein the ionisation source is deactivated during the third period such that it does not ionise the eluant. For example, if an electrospray ionisation source is used then the electrical potential applied to the ionisation source in order to ionise the eluant during the second period may be reduced in the first and/or third periods relative to in the second period, e.g. it may be switched off. During these periods the unionised eluant may pass to a waste conduit. Even if the sample contains potential hazardous material, such as viruses, this material only elutes during the second period in the preferred embodiments and so the eluant can still be sent to waste during the first and/or third periods without being hazardous.

Although embodiments have been described in which the first period may be a period during which no analytes of interest are expected to elute from the separator, and the second period may be a period during which analytes of interest are expected to elute from the separator, it is alternatively contemplated that the method comprises maintaining the liquid flow rate through the separator at the first rate during the first period in which one or more first analytes of interest are expected to elute from the separator, and maintaining the liquid flow rate through the separator at the second rate during the second period in which one or more second analytes of interest are expected to elute from the separator.

The slower flow rate in the second period may assist in enhancing the separation between the second analytes of interest.

The second period may occur after the first period.

The method may comprise measuring or estimating the concentrations of analytes in the sample and determining that a first analyte of interest has a lower concentration than a second analyte of interest. The method may subsequently perform said step of supplying the sample to the liquid chromatography separator, during which the liquid flow rate through the separator is maintained at the first rate when the first analyte of interest is expected to elute from the separator, and the liquid flow rate through the separator is maintained at the second rate when the second analyte of interest is expected to elute from the separator.

According to the method described herein, the ions may have a mass greater than a 0.5×106 Daltons.

The sample may contain viral capsids. Optionally, the method comprises determining the size and/or mass of the capsids.

The separator may be a size-exclusion chromatography separator.

The separator may separate the sample in a liquid chromatography column comprising a bore having an internal diameter of ≤2.5 mm. The use a relatively narrow bore assists in providing the lower flow rate during the second period.

Said ionising may be performed by an electrospray ionisation source.

The eluant from the separator may be ionised by a single ionisation source and the resulting ions, or ions derived therefrom, mass analysed by charge detection mass spectrometry. Alternatively, the method may comprise splitting the eluant from the separator between multiple ionisation sources that form multiple respective streams of ions, wherein the ions in these multiple streams of ions, or fragment or product ions derived therefrom, are then mass analysed by multiple respective charge detection mass analysers.

The method may comprise attenuating ions passing to the mass analyser.

The attenuation may be performed so that the mass analysing performs charge detection mass spectrometry on fewer than a preselected number of ions, such as on a single ion.

Said mass analysing may be performed by a mass analyser that reflects the ions between first and second reflectrons such that they repeatedly pass a charge detector, wherein the mass analyser determines the mass to charge ratio of an ion from the frequency at which it induces an electrical charge on the charge detector, determines the charge state of the ion from the amplitude of the charge that is induced on the charge detector, and determines the mass of the ion from the product of the determined mass to charge ratio and the determined charge state.

The present invention also provides a mass spectrometer configured to perform any of the methods described herein.

Accordingly, the present invention provides a mass spectrometer comprising: a liquid chromatography separator; an ionisation source; a mass analyser configured to perform charge detection mass spectrometry; and control circuitry configured to: control the liquid chromatography separator so as to vary a liquid flow rate through the separator, whilst sample is being supplied to it, such that liquid elutes from the separator at a first rate during a first period and a second, lower rate during a second period; control the ionisation source so as to ionise eluant from the separator during at least the second period; and control the mass analyser to mass analyse the resulting ions, or ions derived therefrom, by charge detection mass spectrometry.

The mass spectrometer may comprise source of said sample and a sample pump for pumping sample to the separator.

The mass spectrometer may comprise source of mobile phase and a mobile phase pump for pumping mobile phase to the separator.

The mass spectrometer may comprise a divert valve for diverting eluant from the separator away from the ionisation source during the first and/or third period.

The mass spectrometer may comprise a control circuitry configured to activate the ionisation source so as to ionise the eluant in the second period, and to deactivate the ionisation source so as to substantially not ionise the eluant in the first and/or third period.

### BRIEF DESCRIPTION OF THE DRAWINGS

Various embodiments of the present invention will now be described, by way of example only, and with reference to the accompanying drawings in which:

FIG. 1 shows an embodiment of a mass spectrometer according to the present invention.

FIG. 2 shows a schematic of a charge detection mass analyser that may be used in the mass spectrometer of FIG. 1.

FIGS. 3A-3D show experimental data obtained for the analysis of a solution containing thyroglobulin and NIST mAb; FIG. 3A shows the intensity of the ion signal detected as a function of elution time from the SEC separator; FIG. 3B shows the mass spectral data for the thyroglobulin peak, plotted as intensity as a function of mass; FIG. 3C shows the mass spectral data for the mAb peak, plotted as intensity as a function of mass; and FIG. 3D shows the mass of the species detected on the y-axis as a function of elution time from the SEC separator.

FIG. 4A and FIG. 4B show experimental data obtained for the analysis of a solution containing bacteriophage Qbeta (Qβ) virus-like particles.

FIG. 5 shows experimental data obtained for the analysis of different concentrations of a sample containing bacteriophage Qbeta (Qβ) virus-like particles.

FIG. 6 shows experimental data obtained for the analysis of a sample containing thyroglobulin and Qβ virus-like particles.

FIG. 7A and FIG. 7B show experimental data obtained for the analysis of a solution containing hepatitis B virus.

### DETAILED DESCRIPTION

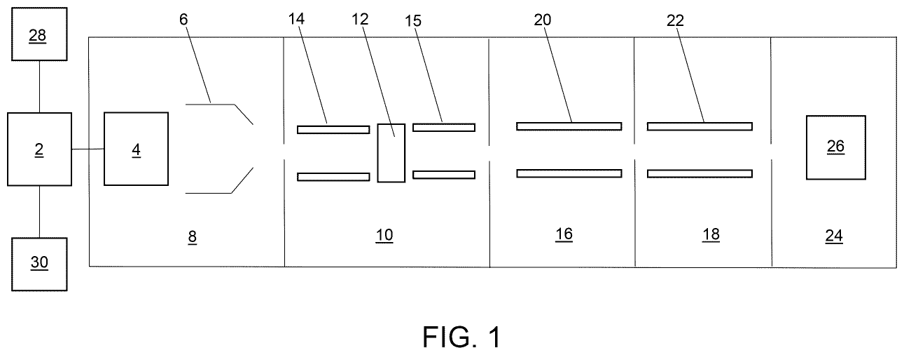

FIG. 1 shows an embodiment of a mass spectrometer according to the present invention. The spectrometer comprises a liquid chromatography (LC) separator 2 for separating a liquid sample, an ionisation source 4 for ionising the sample, and a first ion guide 6 arranged in a first vacuum chamber 8. The ionisation source 4 is preferably an electrospray ionisation source, although other types of ionisation source may be used instead. The first ion guide 6 may be in the form of an ion tunnel ion guide having an ion funnel at its downstream end, although other forms of ion guide may be used instead, or as well. A second vacuum chamber 10 is provided downstream of the first vacuum chamber 8 and comprises an ion attenuation device 12. Ion guides 14,15 are provided for guiding ions to the ion attenuation device 12 and for guiding ions received from the attenuation device. Third and fourth vacuum chambers 16,18 are provided downstream of the second vacuum chamber 10 and comprise ion guides 20,22 for guiding ions therethrough. A fifth vacuum chamber 24 is provided downstream of the fourth vacuum chamber 18 and comprises a charge detection mass analyser 26.

In use, vacuum pumps are used to pump the vacuum chambers down until the mass analyser 26 is at the desired pressure. For example, the first vacuum chamber 8 may be maintained at a pressure of about 5 mbar, although it is contemplated that an atmospheric pressure ionisation source may be used instead and that chamber 8 may be replaced by an atmospheric pressure region. The second vacuum chamber 10 may be maintained at a pressure of about 10-3 mbar, the third vacuum chamber 16 may be maintained at a pressure of approximately 10-5 mbar, and the fourth vacuum chamber 18 may be maintained at a pressure of approximately 10-7 mbar. The fifth vacuum chamber 24 may be maintained at a lower pressure than the fourth vacuum chamber 18, such as a pressure of about 10-9 mbar.

The LC separator 2 is used to separate the sample to be analysed such that different analytes in the sample arrive at the ionisation source 4 and are ionised at different respective times. The LC separator comprises a chromatography column in which the sample is separated. A first pump 28 is provided for pumping the sample into the column of the LC separator 2 and a second pump 30 is provided for pumping a mobile phase to the column. The rates at which these pumps operate may be varied whilst the sample is being supplied to the column in the LC separator 2, as will be described further below. Sample eluting from the LC column arrives at the ionisation source 4 and is ionised. The resulting ions then pass into the first ion guide 6, which radially confines the ions and guides them into the second vacuum chamber 10.

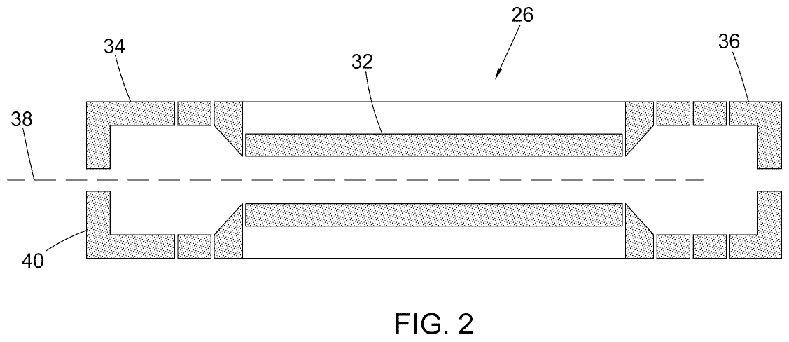

Ions passing into the second vacuum chamber 10 are received in an ion guide 14 and guided to the ion attenuation device 12, which attenuates the ions such that only a proportion of the ions that it receives are onwardly transmitted through in guide 15. Ions that are transmitted by the ion attenuation device are guided into and through the third vacuum chamber 16 by the ion guide 20 therein, and then into and through the fourth vacuum chamber 18 by the ion guide 22 therein. Ions are then then guided into the fifth vacuum chamber 24 and into the charge detection mass analyser 26 therein, which mass analyses ions, e.g. as will be described further below in relation to FIG. 2.

The various ion guides may have an axial electric field maintained across them so as to urge ions therethrough in the downstream direction. This may be achieved, for example, by each of the ion guides being axially segmented and having a voltage supply that applies different DC voltages to different axial segments.

Although an embodiment is shown having five vacuum chambers, it will be appreciated that the present invention is not limited to such an arrangement and that the mass spectrometer may have fewer or more vacuum chambers. Similarly, the mass spectrometer may have different and/or additional ion-optical devices to those shown and described above. For example, the mass spectrometer may comprise a fragmentation device for fragmenting the ions so as to form fragment ions, or a reaction device for reacting the ions with other ions or molecules so as to form product ions. The mass analyser 26 may then analyse the fragment or product ions, rather than the precursor ions.

FIG. 2 shows a schematic of the charge detection mass analyser 26. The mass analyser 26 comprises a charge detector 32 arranged between a first reflectron 34 and a second reflectron 36. In use, voltages are applied to the mass analyser 26 such that ions 38 that are transmitted towards it are able to pass through the first reflectron 34. More specifically, the first reflectron 34 is operated in a transmission mode in which voltages are applied to its electrodes such that ions 38 can pass through its end cap 40 and towards the second reflectron 36. These ions then pass through the charge detector 32 and to the second reflectron 36, where they are reflected back towards the first reflectron 34. In other words, the second reflectron operates as an ion mirror. The ions therefore pass back through the charge detector 32 and head towards the first reflectron 34. Prior to the ions arriving again at the first reflectron, the first reflectron is switched to being operated in an ion mirror mode in which the voltages that are applied to its electrodes are switched such that the first reflectron reflects ions. The ions are therefore reflected by the first reflectron so as to pass back through the charge detector and to the second reflectron.

As will be appreciated, any given ion oscillates between the reflectrons 34,36, and therefore through the charge detector 32, at a frequency that is related to the mass to charge ratio of the ion. Each time that the ion passes through the charge detector 32 it induces an electrical charge on the detector. The mass analyser is configured to determine the frequency at which charge is induced on the charge detector and to calculate the mass to charge ratio of the ion therefrom. The amplitude of the charge that is induced on the detector is related to the electronic charge of the ion (i.e. charge state) and the mass analyser is configured to determine the charge of the ion from this detected amplitude. The mass analyser is configured to then determine the mass of the ion by multiplying the detected mass to charge ratio by the detected charge of the ion. Although the mass analysis of a single ion has been described, it is possible to simultaneously perform the mass analysis on multiple ions. In such embodiments, the signals induced on the charge detector by the different ions can be deconvolved and used to determine their respective mass to charge ratios, electronic charges and masses.

The voltages applied to the mass analyser are maintained until the one or more ions being analysed have been reflected through the charge detector for the desired duration, after which the voltages may be controlled so as to cause the one or more ions to be discarded, such as by impacting on an electrode, or by being released from the mass analyser. For example, the ions may be allowed to exit through the end cap of one or both reflectrons. The mass analyser may then be controlled to admit one or more further ions to be mass analysed, and the above process is repeated on these ions.

In order to achieve an acceptable charge accuracy, each ion being mass analysed may be required to be trapped between the reflectrons for a relatively long time, such as hundreds of milliseconds. One consequence of this is that when multiple ions are trapped simultaneously between the reflectrons there is a relatively high probability that they will interact with one another, which changes the energies of the ions and complicates the interpretation of the resulting mass spectral data. To try and mitigate this problem, the mass spectrometer may be operated such that only a single ion is trapped between the reflectrons at any given time. However, this then requires a relatively long time to build up a mass spectrum for all of the ions of interest.

It is desirable to separate analytical samples by liquid chromatography, such as size exclusion chromatography (SEC), prior to ionising the sample and mass analysing the resulting ions by CDMS. For example, such analysis techniques would assist in characterising drugs for cell and gene therapy, e.g. in order to quickly profile the masses of relatively heavy molecules, e.g. with a mass of more than 0.5 MDa, such as viral vectors. However, the timescales over which analyte peaks elute from LC separators are not well matched with the timescale for performing CDMS.

It is desirable to cause the sample to elute from the LC separator 2 at a relatively slow rate, so that when it is ionised by the ionisation source 4 the ion flux passing towards the charge detection mass analyser 26 is relatively low. This reduces the amount of attenuation required by the attenuation device 12 and also assists in trapping the desired number of ions in the mass analyser 26 during mass analysis. However, in order to reduce the overall time of the experiment, it has been recognised that the speed at which liquid is pumped through the LC separator should be varied.

More specifically, when a sample is analysed by LC mass spectrometry, the portion of the eluant that first elutes from the LC separator during a first period consists substantially only of the mobile phase used for carrying the sample and not any of the sample itself. The portion of the eluant that next elutes from the LC separator, during a second period, contains the separated analytes of interest from the sample, such as proteins from the sample. The portion of the eluant that next elutes from the LC separator, during a third period, contains no analytes of interest. For example, only compounds that are of no analytical interest, such as salts, may elute during the third period. As the eluant does not contain analytes of interest from the sample during the first and third periods, embodiments of the present invention provide a relatively high fluid flow rate through the LC separator during these periods and a slower fluid flow rate through the LC separator during the second period. The flow rate used in the second period may be controlled so that the duration of at least some of the chromatographic peak widths substantially match the duty cycle of the mass analyser. The reduced flow rate used in the second period may also be the flow rate that is optimised for the type of ionisation source being used, such as an electrospray ionisation source.

The flow rate through the LC separator 2 is varied whilst the sample is supplied to the LC column of the separator 2 by varying the speed of the mobile phase pump 30 and/or the speed of the sample pump 28. More specifically, the sample pump 28 and mobile phase pump 30 are operated so as to supply sample and mobile phase into the LC separator 2, but the rate at which pump 30 supplies mobile phase to the LC separator and/or the rate at which pump 28 supplies sample to the LC separator is varied so as to be slower during the second period than in the first and third periods. For example, fluid may be caused to flow through the LC separator during the first period at a first rate that is at least twice as high as the flow rate during the second period. Additionally, or alternatively, fluid may be caused to flow through the LC separator during the third period at a third rate that is at least twice as high as the flow rate during the second period. For instance, each of the first and third flow rates may be about 50 μL/min and the second flow rate may be about 10 μL/min. The flow rate may be a typical flow rate used in LC mass spectrometry during the first and third periods, and slowed during the second period. For example, a chromatographic peak width that would typically be about 20 seconds wide could be lengthened to between 40 and 300 seconds during the second period.

The eluant from the LC separator 2 must pass to the ionisation source 4 during the second period, such that analytes of interest in the sample are ionised and subsequently mass analysed by mass analyser 26. The eluant may also pass to the ionisation device during the first and third periods. Alternatively, the eluant may be diverted away from the ionisation source, e.g. to waste, during the first and/or third period. This helps prevent contamination of the ion-optical elements in the mass spectrometer. This is particularly advantageous during the third period, so as to prevent salts from the sample being ionised and the resulting ions transmitted into the mass spectrometer.

Alternatively, rather than diverting the eluant away from the ionisation source during the first and/or third period, the eluant may be supplied to the ionisation source, but the ionisation source may be deactivated during the first and/or third period such that it does not ionise the eluant. For example, if an electrospray ionisation source is used then the electrical potential applied to the source in order to ionise the eluant may be reduced in the first and/or third periods relative to the electrical potential applied to the source in the second period, e.g. it may be switched off. During such periods the unionised eluant may remain in liquid form and pass to a waste conduit. Even if the sample being analysed contains potentially hazardous material, such as viral material, this material elutes during the second period and so the eluant can still be sent to waste during the first and/or third periods without significantly increasing the hazard risk.

As described above, the mass spectrometer is controlled to switch the flow rate through the LC separator from a relatively fast first flow rate to a slower second flow rate when one or more analyte of interest is expected to start eluting from the LC separator, and to switch the flow rate through the LC separator from the second flow rate to a faster third flow rate when the one or more analyte of interest is expected to have finished eluting from the LC separator. The time at which one or more analyte of interest in the sample is expected to start eluting from the LC separator may be known or estimated, e.g. estimated based on theoretical calculations. For example, a portion of the sample, or a similar or duplicate sample, may have been mass analysed previously in order to determine the time at which the one or more analyte of interest starts eluting from the LC separator. When the sample is subsequently mass analysed, the mass spectrometer may be configured to automatically switch the flow rate through the LC separator from the first flow rate to the second flow rate at a time that is based on the time at which the one or more analyte of interest is expected to start eluting from the LC separator. For instance, the mass spectrometer may switch the flow rate from the first rate to the second rate at or before the time that is has been determined, or is known, that the one or more analyte of interest will start eluting from the LC separator.

In a corresponding manner, the time at which the one or more analyte of interest in the sample is expected to finish eluting from the LC separator may be known or estimated. When the sample is mass analysed, the mass spectrometer may be configured to automatically switch the flow rate through the LC separator from the second flow rate to the third flow rate at a time that is based on the time at which the one or more analyte of interest is expected to finish eluting from the LC separator. For instance, the mass spectrometer may switch the flow rate from the second rate to the third rate at or after the time that is has been determined, or is known, that the one or more analyte of interest will finish eluting from the LC separator.

Alternatively, the sample may be spiked with a marker compound and when the mass analyser mass analyses and detects ions of the marker compound it automatically switches the flow rate through the LC separator from the first flow rate to the second flow rate. It will be appreciated that the marker compound is selected to be a compound that elutes from the LC separator prior to or during the elution of the one or more analytes of interest. The mass spectrometer may maintain the second flow rate until the marker compound is no longer detected, or for a predetermined time after its detection, and then switch the flow rate to the third flow rate. Alternatively, the sample may be spiked with a further marker compound and when the mass analyser mass analyses and detects ions of that further marker compound it automatically switches the flow rate through the LC separator from the second flow rate to the third flow rate. It will be appreciated that the further marker compound is selected to be a compound that elutes from the LC separator after the elution of the one or more analytes of interest.

Although embodiments have been described above in which the analytes of interest only elute during the first period and not during the second and third periods in which the flow rate is different, it is alternatively contemplated that one or more first analyte of interest from the sample may elute during the first period and one or more second analyte of interest may elute from the separator during the second period. The slower flow rate through the LC separator in the second period may assist in enhancing the separation between the second analytes of interest. Alternatively, or additionally, the one or more second analyte of interest may be expected to have a higher concentration than the one or more first analyte of interest (e.g. this may have been determined from their peak heights in a preceding experiment). The slower flow rate through the LC separator in the second period may assist in matching the timescale over which the one or more second analyte peak elutes from the LC separator with the timescale for performing CDMS.

Embodiments of the present invention use a relatively narrow bore column in the LC separator in order to assist in providing the slower flow rate during the second period, and so that the rate of sample consumption is relatively low. For example, the inner diameter of the bore may be ≤2.5 mm, e.g. about 2.1 mm. Such a column provides a flow rate that is about four times slower than for a standard column having a 4.1 mm bore, at the same pressure.

Experiments are described below that demonstrate the ability of LC-CDMS to analyse various different analytes. The materials used in these experiments were: ammonium acetate (09691), OmniSolv LC-MS water (WX0001), thyroglobulin (T1001), and bovine serum albumin (A2153) purchased from Millipore Sigma; formic acid purchased from VWR (64-18-6); bacteriophage Qbeta (Qβ) purchased from Fina Biosolutions; NIST monoclonal reference standard (NISTmAb) purchased from National Institute of Standards and Technology Office of Reference Material (14HB-D-002); and truncated hepatitis B virus capsid protein (Cp149) assembled in 300 mM sodium chloride for 24 hours to yield T=3 and T=4 capsids. The samples were diluted to a final concentration of 1 μg/μL before analysis.

The experiments were conducted using native SEC separations performed on a Waters Acquity UPLC M-Class system equipped with a widepore SEC column (2.1 mm×300 mm) and a 5 μL sample loop. The flow rates through the SEC column and mobile phase for all separations are shown in Table 1 below. Following column elution, the flow rate was reduced just before the electrospray emitter, with a MicroCross PEEK fitting (Idex P-889) to allow flow into a 15 μm electrospray emitter tip or to waste. The fourth arm of the PEEK fitting was used for a high voltage electrical connection for electrospray ionization.

TABLE 1

| Time | Flow Rate | Solvent A | Solvent B |
|---|---|---|---|
| (min) | (μL/min) | (Water + 0.1% FA) | (200 mM AmAc) |
| 0 | 35 | 50 | 50 |
| 20 | 35 | 1 | 99 |
| 20.5 | 20 | 1 | 99 |
| 29 | 20 | 50 | 50 |
| 30 | 10 | 100 | 0 |

As shown in Table 1 above, the flow rate through the SEC column was reduced at 20.5 minutes. In experiments described below this is after some analytes of interest have eluted from the SEC column, but before other analytes of interest have eluted. The flow rate through the SEC column was reduced again at 30 minutes in order to elute the salt band. However, as described above, the flow rate may instead be increased in order to elute the salt band.

The samples were analysed using a CDMS instrument. Ions entered the instrument through a metal capillary and were thermalised in an ion guiding device that is optimized for the transmission of a wide range of masses. Ions were the transmitted through an RF only hexapole ion guide and a segmented RF only quadrupole ion guide, before being focused into an energy analyser that selects ions having a narrow band of kinetic energies that is centred on 130 eV per charge and transmits these ions into an electrostatic linear ion trap for charge and mass detection. Ions were measured in a random trapping mode, with 104.6 ms events that give a charge RMSD of ˜0.6 e. All trapping events were timestamped and matched to the SEC injection.

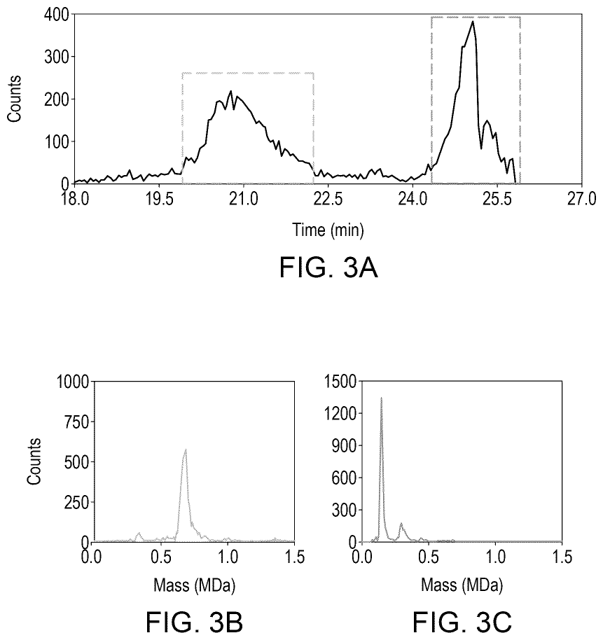

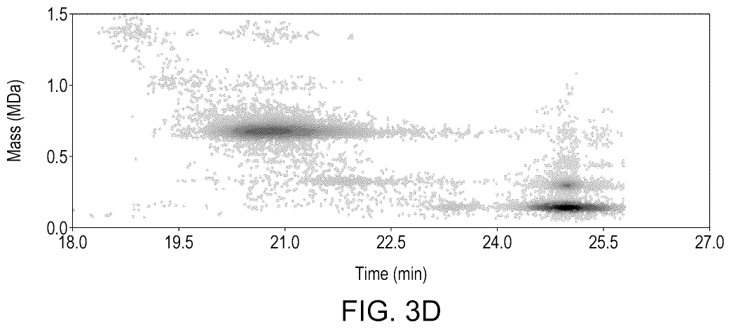

FIGS. 3A-3D show experimental data obtained for the analysis of a solution containing thyroglobulin and NIST mAb. Thyroglobulin is a protein precursor of thyroid hormones and presents as a homodimeric glycoprotein having a mass of 660 kDa, whilst NIST mAb has a mass of about 148 kDa. FIG. 3A shows the intensity of the ion signal detected as a function of elution time from the SEC separator. The peak in the left dashed box that elutes between 19.75 and 22 minutes is the peak for thyroglobulin, whereas the later peak in the right dashed box that elutes between 24.25 and 26 minutes is mAb. FIG. 3B shows the mass spectral data for the thyroglobulin peak, plotted as intensity as a function of mass. It can be seen that thyroglobulin has a sharp, main peak at 675 kDa. The full width at half maximum (FWHM) for the dimeric glycoprotein is 58 kDa, which is well within the expected width when taking into account potential glycoforms of the protein. FIG. 3C shows the mass spectral data for the mAb peak, plotted as intensity as a function of mass. It can be seen that mAb has a main peak at 148.26 kDa, with a FWHM of 19 kDa.

In the spectra described above 5168 ions were measured for the thyroglobulin dimer and 4638 ions were measured for the NIST IgG monomer. The peaks were collected in 2.25 minutes and 1.75 minutes, respectively. These ion counts indicate that the elution window for each analyte was greater than required for a quality analysis of these molecules and that faster elution times could be used whilst still obtaining a quality analysis. Utilizing a multiple ion charge extraction algorithm ensures that ions having overlapping mass to charge ratios are not lost.

FIG. 3D shows the mass of the species detected on the y-axis as a function of elution time from the SEC separator. The intensity of the shading represents the intensity with which the ions are detected. From this it is clearly visible that relatively low abundance species are identifiable. For example, before the elution of the main thyroglobulin peak there is a defined mass at 1.355 MDa and another at 1.01 MDa. These masses align well with the multimers of the thyroglobulin tetramer and trimer respectively. The data shown here also shows the entire elution of the thyroglobulin and mAb mixture. Starting at an elution time of 19 minutes we see the dimer thyroglobulin dimers eluting followed by a trimer of thyroglobulin monomers at 19.5 minutes. Following this we see the primary thyroglobulin dimer elute at 20.75 minutes, followed by the monomer of thyroglobulin at 21.75 minutes. Finally, at roughly 24.8 minutes the NIST IgG monomer and dimer elute together. Across all primary peaks collected, some bleed occurs for each analyte. The single particle analysis of SEC-CDMS described herein allows for the quantification and identification of these molecules, which would be seen as an unidentifiable background signal on other instruments.

In the experiment described above a 3 μm 1000 Å SEC column that is optimised for separation of larger particles was used. In this separation the only species that elutes slightly differently is the dimer of the NIST IgG, which elutes at the same time as the monomer.

As described above, thyroglobulin and NIST mAb were easily separated using the above flow parameters. Experiments were also performed to demonstrate that large molecules can be separated using the techniques described herein, such as analytes that have masses beyond the upper mass limit of conventional mass spectrometry. For example, the techniques described herein may be used to analyse bacteriophage Qbeta (Qβ) virus-like particles.

Bacteriophage Qbeta (Qβ) virus-like particles have shown recent promise in becoming vaccine carriers. Qβ has been reported to exhibit several structural geometries, including T=1 (60 capsid proteins) and T=3 (180 capsid proteins). When capsid proteins are overexpressed, even more geometries are observed. A sample was created containing Qβ virus-like particles. The sample was spiked with bovine serum albumin (BSA) for serving as a marker to denote that the elution of the Qβ particles was complete and to therefore indicate when to turn off the ESI ionisation source in order to avoid electrospraying the salt band from the sample.

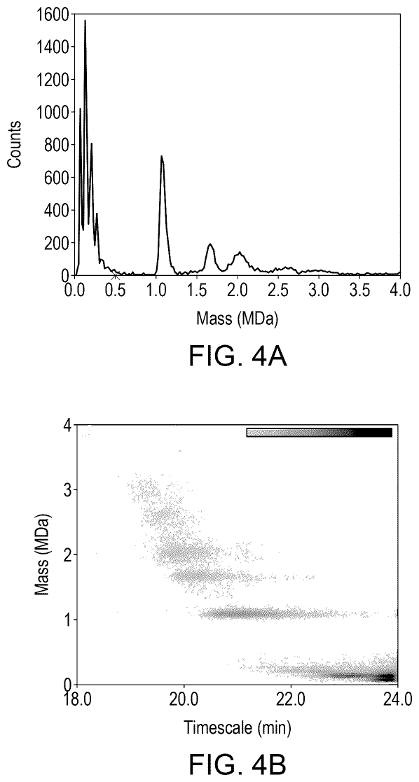

FIG. 4A shows the intensity of the ion signal detected as a function of mass of the particles. This mass spectra shows peaks were expected from the known literature, i.e. peaks corresponding to 60, 90, 120, 150 and 180 capsid proteins at 1.09, 1.68, 2.05, 2.61 and 3.02 MDa respectively. FIG. 4B shows the data of FIG. 4A, but plotted as mass as a function of elution time from the SEC separator. Additional information regarding the sizes of the molecules can be elucidated from this. The clear separation of each constituent at differing timepoints can be seen in FIG. 4B. Previous studies predicted that these mass peaks correlated to different capsid structures, and this experiment confirms the additional mass is from the T=1 icosahedron to a T=3 structure. The first to elute is the T=3 structure at 19.4 min. The T=3 oblate structures then elute at 19.7 minutes, followed by the pseudo T=2 structure at 20.02 minutes, T=1 prolate structure at 20.36 minutes and lastly the T=1 structure at 21.14 minutes. Multimers of BSA start to elute at 22.31 and the BSA monomer appears at 23.7 minutes. As described above, BSA was included as a marker to indicate when the Qβ structures had finished eluting from the SEC separator. When the BSA was detected the analysis of the sample was ended, at an elution time of 24 minutes, so as not to analyse the salt band from the sample. In total, 15,603 ions were detected in the mass spectra data.

Although the elution times of the different Qβ structures overlap, by coupling the SEC separator to a CDMS instrument it is easy to elucidate the structures by mass, unlike with other technique such as TUV or MALS, where the peak overlap could cause mis-assignment. In this example the varying structures of Qβ can easily be separated from one another and can be independently analysed if so desired, showing that even higher mass analytes may be analysed according to the techniques described herein.

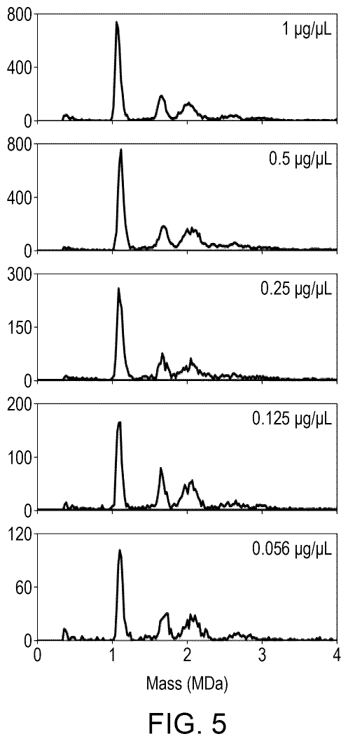

To further quantify the limitations of SEC-CDMS, a dilution study of Qβ was performed, again using BSA as a marker to denote the end of the elution of the Qβ particles. A sample containing an initial Qβ concentration of 1 μg/μL and 0.33 μg/μL BSA was serially diluted down to produce samples having different concentrations of these analytes, down to a Qβ concentration of 0.056 μg/μL and a BSA concentration of 0.01848 μg/μL. These samples were then mass analysed so as to obtain the mass spectral data shown in FIG. 5. The analysis was truncated as soon as the first BSA ion was detected and the BSA peaks are removed from FIG. 5, as they were only used as an indicator to mark that the Qβ particles had finished eluting.

As can be seen from FIG. 5, as the concentration of Qβ in the sample decreases, the overall number of counts for the Qβ peaks generally decreases, as expected. At Qβ concentrations of 1 μg/μL, 0.5 μg/μL, 0.25 μg/μL, 0.125 μg/μL and 0.056 μg/μL, the total ion counts were 7766, 9389, 2890, 2022 and 1264, respectively. Although the ion counts did not always decrease with decreasing concentration, as expected, this was due to the large ion signal causing saturation of the CDMS detector. A decrease in ion signal was observed as the concentration of Qβ in the sample was reduced, yet the relative ratios of the various Qβ geometries remains consistent. The ion signal intensity for the T=1 structure had values of 3289, 3504, 1248, 772 and 464 in the respective samples, due to the samples decreasing in concentration. The 1 μg/μL and 0.5 μg/μL concentration samples had nearly identical T=1 peak heights and a generally similar total ion count for the spectra. This can be attributed to a very large influx of ion signal for these peaks, which reaches the saturation limit of the CDMS detector, i.e. roughly 150 ions/s for these samples.

This experiment shows that the technique described herein can be used to analyse analytes over a wide range of concentrations whilst obtaining count rates competitive with traditional mass spectrometers. However, when analysing low concentration samples, ions can be accumulated and pulsed into the CDMS so as to increase the ion count, e.g. by a factor of 10 or more.

The experiments described above verify that SEC separators can be coupled to CDMS. However, CDMS can also provide benefits to liquid chromatography that other types of mass spectrometers are not able to provide.

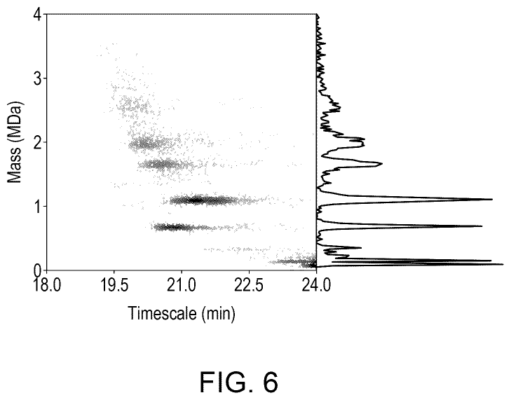

FIG. 6 shows experimental data obtained using an analysis technique according to an embodiment of the invention for the analysis of a sample containing thyroglobulin and Qβ virus-like particles. The plot shows the mass of the species detected by CDMS on the y-axis as a function of elution time from a SEC LC separator. The intensity of the shading represents the intensity with which the ions are detected. The intensity profile is also shown extending horizontally from the right of the box that surrounds it. It can be seen that the same series of Qβ geometries elute at the same times as in FIG. 4. In addition to this, a thyroglobulin dimer peak can be seen to elute at 20.75 minutes, as also shown in FIG. 3A.

It is clear from FIG. 6 that, due to the number of overlapping peaks present in this chromatogram, minimal structural information could be resolved using conventional mass spectrometers due to the difficulty in deconvoluting and identifying structures. Conventional UV analysis techniques would also yield minimal differences, since these compounds all absorb at similar wavelengths. However, utilising the CDMS techniques of the present invention it is possible to denote the specific mass intensities of the analytes even when the chromatogram resolution is not entirely sufficient to identify species of interest.

It can be seen that the elution time of the thyroglobulin dimer is earlier than the T=1 Qβ structure, while having just over half the total mass. This offers structural information regarding the relative sizes of their hydrodynamic radii. The thyroglobulin dimer has a size of 8.6 nm and elutes close to the T=1 prolate structure of Qβ, indicating that their hydrodynamic radii should be similar. The chromatogram depicts only a small portion of the applications that CDMS can be applied to. Limitations regarding heterogeneity limited the ability for traditional mass spectrometry to identify molecules of this size and above.

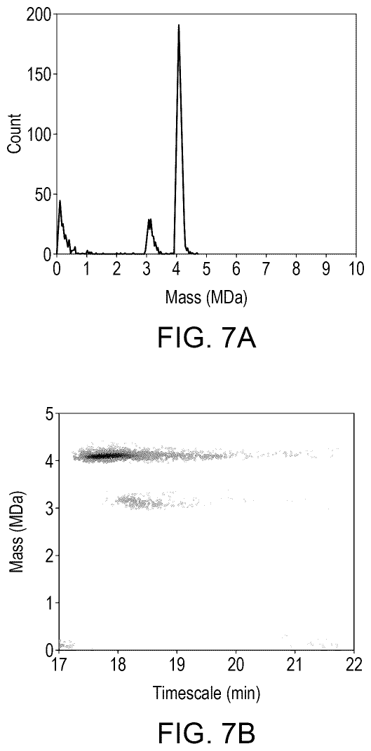

A further experiment was performed in which a sample containing hepatitis B virus (HBV) was analysed. HBV has a dimeric capsid protein that assembles into T=3 and T=4 icosahedral capsids. A truncated version of the HBV core protein CP149 was run through the SEC column ramp described above and then mass analysed by CDMS. The resulting mass spectrum and mass chromatogram are shown in FIGS. 7A and 7B, respectively.

The mass spectrum depicted in FIG. 7A shows peaks for the T=4 HBV capsids (4.10 MDa) and T=3 HBV capsids (3.13 MDa), with some dimer multimers present. The expected masses of the Cp149 particles are 4.02 and 3.02 MDa, with previous CDMS results ranging from 4.04 to 4.10 and 3.03 to 3.20 MDa depending on the resolution of the detector. The T=3 and T=4 peaks in FIG. 7A are well within the masses expected for these large electrosprayed ions. Although the FWHM of the T=4 capsids was 147 kDa, which is broader than previously reported, this is not unexpected when considering counterions, residual solvent and salt adducts from the larger ESI emitter used. More specifically, the ESI emitter used in this experiment was 15 μm, to accommodate the higher flow rate from the SEC column, which is almost 10 times larger than the 250 nm tips conventionally used in high-resolution experiments. This mass overage can be further optimized by either reducing the size of the emitter (and providing flow splitting) or by introducing further desolvation techniques upon entering the instrument.

FIG. 7B shows clear separation between loose dimers and the T=3 and T=4 HBV capsids. The elution time of T=4 appears at 17.8 minutes, while T=3 elutes at 18.1 minutes. The total ion count present in this spectrum is 1489 ions, with the T=4 peak containing 983 ions and the T=3 peak containing 220 ions. The ability to separate the T=3 and T=4 structures of HBV can be taken further in identifying stability differences between the structures.

Although the present invention has been described with reference to various embodiments, it will be understood by those skilled in the art that various changes in form and detail may be made without departing from the scope of the invention as set forth in the accompanying claims.

For example, although a particular type of CDMS mass analyser is shown and described herein, it will be appreciated that other types of CDMS mass analysers may be used in embodiments of the present invention.

Embodiments have been described in which a sample is separated in an LC separator and the flow rate through the separator is varied from an initial fast rate during a first period when no analytes of interest are expected to elute, to a slower rate when one or more analytes of interest are expected to elute, and then to a faster rate when the one or more analytes of interest are expected to have eluted. However, it is contemplated that analytes of interest may be separated by an elution duration in which there are no analytes of interest. In such embodiments, the flow rate through the separator may be varied from an initial fast rate during a first period when no analytes of interest are expected to elute, to a slower rate when one or more analytes of interest are expected to elute, and then to a faster rate when the one or more analytes of interest are expected to have eluted, and then to a slower rate when one or more further analytes of interest are expected to elute, and then to a faster rate when the one or more further analytes of interest are expected to have eluted.

Embodiments have been described in which the eluant from the LC separator 2 is ionised by a single ionisation source 4 and the resulting ions, or ions derived therefrom, are mass analysed in the mass analyser 26. However, other embodiments are contemplated in which the eluant from the LC separator is split between multiple ionisation sources so as to form multiple respective streams of ions. The ions in these multiple streams of ions, or fragment or product ions derived therefrom, are then mass analysed by multiple respective charge detection mass analysers. For example, these ions may be simultaneously mass analysed by the multiple charge detection mass analysers.

1. A method of mass spectrometry comprising:
supplying a sample to be mass analysed to a liquid chromatography separator, whilst varying a liquid flow rate through the separator such that liquid elutes from the separator at a first rate during a first period and a second, lower rate during a second period;
ionising eluant from the separator during at least the second period; and
mass analysing the resulting ions, or ions derived therefrom, by charge detection mass spectrometry.

2. The method of claim 1, wherein the first period is an initial period during which the sample does not elute from the separator, and the second period is a subsequent period during which the sample does elute from the separator; and/or
wherein the first period is a period during which no analytes of interest are expected to elute from the separator, and the second period is a period during which one or more analytes of interest are expected to elute from the separator.

3. The method of claim 1, wherein said supplying the sample to the separator comprises pumping both the sample and a mobile phase to the separator during the first and second periods, wherein only the mobile phase elutes during the first period.

4. The method of claim 1, wherein the sample is supplied to the separator whilst varying the liquid flow rate through the separator such that liquid elutes from the separator at a third rate during a third period that is subsequent to the second period, wherein the third rate is higher than the second rate.

5. The method of claim 4, wherein no analytes of interest are expected to elute from the separator during the third period.

6. The method of claim 1, comprising switching the liquid flow rate through the separator from the first flow rate to the second flow rate when a first predetermined volume of liquid has eluted from the separator; and/or
switching the liquid flow rate through the separator from the second flow rate to the third flow rate when a second predetermined volume of liquid has eluted from the separator.

7. The method of claim 1, comprising switching the liquid flow rate through the separator from the first flow rate to the second flow rate at a time based on when one or more analyte of interest is expected to start eluting from the separator; and/or switching the liquid flow rate through the separator from the second flow rate to the third flow rate at a time based on when the one or more analyte of interest is expected to have finished eluting from the separator.

8. The method of claim 1, comprising spiking the sample with a first marker compound, wherein when the mass analyser mass analyses and detects ions of the first marker compound it automatically switches the flow rate through the separator from the first flow rate to the second flow rate; and/or
wherein the sample is spiked with a second marker compound and when the mass analyser mass analyses and detects ions of that second marker compound it automatically switches the flow rate through the separator from the second flow rate to the third flow rate.

9. The method of claim 1, wherein said supplying the sample to the separator comprises:
(i) pumping a mobile phase to the separator during the first and second periods, wherein the mobile phase is pumped to the separator at a lower rate during the second period than during the first and/or third period; and/or
(ii) pumping the sample to the separator at a lower rate during the second period than during the first and/or third period.

10. The method of claim 1, wherein liquid is caused to elute from the separator during the first and/or third period at a rate that is at least twice as high as during the second period.

11. The method of claim 1, where said ionising is performed by an ionisation source and the method comprises diverting eluant from the separator away from the ionisation source during the first and/or third period.

12. The method of claim 1, where said ionising is performed by an ionisation source, optionally an electrospray ionisation source, and the method comprises supplying eluant from the separator to the ionisation source during the first period, but wherein the ionisation source is deactivated during the first period such that it does not ionise the eluant; and/or supplying eluant from the separator to the ionisation source during the third period, but wherein the ionisation source is deactivated during the third period such that it does not ionise the eluant.

13. The method of claim 1, comprising maintaining the liquid flow rate through the separator at the first rate during the first period in which one or more first analytes of interest are expected to elute from the separator, and maintaining the liquid flow rate through the separator at the second rate during the second period in which one or more second analytes of interest are expected to elute from the separator.

14. The method of claim 1, comprising measuring or estimating the concentrations of analytes in the sample and determining that a first analyte of interest has a lower concentration than a second analyte of interest, wherein the method subsequently performs said step of supplying the sample to the liquid chromatography separator, during which the liquid flow rate through the separator is maintained at the first rate when the first analyte of interest is expected to elute from the separator, and the liquid flow rate through the separator is maintained at the second rate when the second analyte of interest is expected to elute from the separator.

15. The method of claim 1, wherein the ions have a mass greater than a 0.5×106 Daltons, and/or the sample contains viral capsids; optionally wherein the method comprises determining the size and/or mass of the capsids.

16. The method of claim 1, wherein the separator is a size-exclusion chromatography separator, and/or the separator separates the sample in a 1 liquid chromatography column comprising a bore having an internal diameter of ≤2.5 mm.

17. The method of claim 1, further comprising splitting the eluant from the separator between multiple ionisation sources that form multiple respective streams of ions, wherein the ions in these multiple streams of ions, or fragment or product ions derived therefrom, are then mass analysed by multiple respective charge detection mass analysers.

18. The method of claim 1, further comprising attenuating ions passing to the mass analyser.

19. The method of claim 1, wherein said mass analysing is performed by a mass analyser that reflects the ions between first and second reflectrons such that they repeatedly pass a charge detector, wherein the mass analyser determines the mass to charge ratio of an ion from the frequency at which it induces an electrical charge on the charge detector, determines the charge state of the ion from the amplitude of the charge that is induced on the charge detector, and determines the mass of the ion from the product of the determined mass to charge ratio and the determined charge state.

20. A mass spectrometer comprising:
a liquid chromatography separator;
an ionisation source;
a mass analyser configured to perform charge detection mass spectrometry; and
control circuitry configured to:
control the liquid chromatography separator so as to vary a liquid flow rate through the separator, whilst sample is being supplied to it, such that liquid elutes from the separator at a first rate during a first period and a second, lower rate during a second period;
control the ionisation source so as to ionise eluant from the separator during at least the second period; and
control the mass analyser to mass analyse the resulting ions, or ions derived therefrom, by charge detection mass spectrometry.
